(19) United States
(12) Patent Application Publication
(10) Pub. No.: US 2022/0120064 A1
(43) Pub. Date: Apr. 21, 2022

(54) HANGING DEVICE AND COMBINED SHOWER

(71) Applicant: Xiamen Solex High-Tech Industries Co., Ltd., Xiamen (CN)

(72) Inventors: Zhichun LIN, Xiamen (CN); Qingxin Fu, Xiamen (CN); Donghai Chen, Xiamen (CN)

(21) Appl. No.: 17/505,800

(22) Filed: Oct. 20, 2021

(30) Foreign Application Priority Data
Oct. 20, 2020 (CN) 202011127312.0

(51) Int. Cl. E03C 1/04; B05B 15/62

(52) U.S. Cl. CPC E03C 1/0408; B05B 15/62

(57) ABSTRACT

The present disclosure discloses a hanging device and a combined shower. The hanging device comprises a hanging portion, an inserting portion, a locking mechanism, and an attraction mechanism. The inserting portion is configured to be connected to the hanging portion, and the attraction mechanism is disposed between the hanging portion and the inserting portion and is configured to generate an attraction force. The attraction force enables the hanging portion and the inserting portion to be attracted to each other. The locking mechanism is disposed between the hanging portion and the inserting portion. The attraction force enables the locking mechanism to be changed from an unlocked state to a locked state and to continue to be in the locked state. The locking mechanism is configured to be changed from the locked state to the unlocked state by overcoming the attraction force.

### RELATED APPLICATIONS

This application claims priority to Chinese patent application number 202011127312.0, filed on Oct. 20, 2020. Chinese patent application number 202011127312.0 is incorporated herein by reference.

### FIELD OF THE DISCLOSURE

The present disclosure relates to a field of bathroom fixtures, and in particular to a hanging device and combined shower.

### BACKGROUND OF THE DISCLOSURE

Existing wall bracket devices comprise a first magnetic element mounted on a shower head having an inserting hole located on a center portion of the shower head and a second magnetic element mounted on a wall bracket. The wall bracket comprises an inserting post on which the inserting hole is sleeved. The shower head is magnetically attracted to the wall bracket through the first magnetic element and the second magnetic element. The existing wall bracket devices realize positioning through the inserting structures that are coupled to each other along a front-rear direction cooperating with the magnetic elements, which is not easy to take down and needs to be improved.

### BRIEF SUMMARY OF THE DISCLOSURE

The present disclosure provides a hanging device and a combined shower to solve the deficiencies in the background.

In order to solve the technical problem, a first technical solution of the present disclosure is as follows.

A hanging device comprises a hanging portion, an inserting portion, a locking mechanism, and an attraction mechanism. The inserting portion is configured to be connected to the hanging portion, and the attraction mechanism is disposed between the hanging portion and the inserting portion and is configured to generate an attraction force. The attraction force enables the hanging portion and the inserting portion to be attracted to each other, and the locking mechanism is disposed between the hanging portion and the inserting portion. The attraction force enables the locking mechanism to be changed from an unlocked state to a locked state and to continue to be in the locked state, and the locking mechanism is configured to be changed from the locked state to the unlocked state by overcoming the attraction force.

In a preferred embodiment, the hanging portion comprises an inserting groove having an opening facing downward, and the inserting portion is configured to be inserted upward into the inserting groove.

In a preferred embodiment, the hanging portion comprises an inserting groove having an opening facing upward, and the inserting portion is configured to be inserted downward into the inserting groove.

In a preferred embodiment, the attraction force is a magnetic attraction force, the attraction mechanism comprises a first member and a second member that are configured to be magnetically attracted to each other, and the first member and second member are respectively disposed on the hanging portion and the inserting portion.

In a preferred embodiment, the first member is disposed on a bottom of the inserting groove, the second member is disposed on a distal end of the inserting portion, and the magnetic attraction force is disposed along an inserting direction in which the inserting portion is inserted into the inserting groove.

In a preferred embodiment, the locking mechanism comprises a locking protrusion protruding from a groove wall of the inserting groove and a recess recessed on the inserting portion, and when the locking protrusion is inserted into the recess, the locking mechanism is in the locked state.

In a preferred embodiment, the attraction force is configured to drive the inserting portion to move toward a bottom of the inserting groove. When the inserting portion contacts the locking protrusion, the inserting portion is pushed away from the locking protrusion and moves to be in the locked state due to the locking mechanism.

In a preferred embodiment, the hanging portion and the inserting portion are disposed with a first guiding mechanism. The first guiding mechanism comprises a first matching surface located on a lower end surface of the hanging portion and having a first concavo-convex structure and a second matching surface located on an upper end surface of the inserting portion and having a second concavo-convex structure. The first matching surface and the second matching surface are matched with each other.

In a preferred embodiment, a second guiding mechanism is disposed between the inserting portion and the locking protrusion. When the inserting portion contacts the locking protrusion, the inserting portion is guided to move to be in the locked state through the second guiding mechanism cooperating with the attraction force that drives the inserting portion to move toward the bottom of the inserting groove.

In a preferred embodiment, an upper end surface the inserting portion comprises a sliding groove, and a sliding piece is slidingly connected to the sliding groove. The sliding piece comprises the recess, and an outermost sliding position at which the sliding piece is configured to move outward relative to the inserting portion corresponds to the locked state of the locking mechanism.

In a preferred embodiment, an elastic body configured to drive the sliding piece to move inwardly relative to the inserting portion is disposed between the sliding piece and the inserting portion.

In a preferred embodiment, a gap is defined between the inserting groove and the inserting portion, and the gap defines a space-providing space into which the inserting portion is configured to move to bypass the locking protrusion to enable the locking mechanism to be changed to be in the unlocked state.

A second technical solution of the present disclosure is as follows.

A hanging device comprises a hanging portion, a locking mechanism, and an inserting portion. The hanging portion comprises an inserting groove having an opening facing downward, and the inserting portion is configured to be connected upward to the hanging portion. The locking mechanism is disposed between the hanging portion and the inserting portion, and the inserting portion comprises a connecting head configured to undergo elastic deformation. The locking mechanism comprises a locking protrusion protruding from a groove wall of the inserting groove and a recess recessed on the connecting head. When the locking protrusion is inserted into the recess, the locking mechanism is in a locked state.

In a preferred embodiment, an attraction mechanism configured to generate an attraction force is disposed between the hanging portion and the inserting portion, and the attraction force enables the hanging portion and the inserting portion to be attracted to each other. A first guiding mechanism is disposed between the hanging portion and the inserting portion, and the attraction force is configured to drive the inserting portion to move toward a bottom of the inserting groove. When the inserting portion contacts the locking protrusion, the attraction force makes the connecting head undergo elastic deformation through the first guiding mechanism to enable the locking protrusion to be inserted into the recess after the connecting head is pushed and reset to an original shape.

In a preferred embodiment, a second guiding mechanism is disposed between the locking protrusion and the inserting portion. When the inserting portion contacts the locking protrusion, an attraction force makes the connecting head undergo elastic deformation through the second guiding mechanism to enable the locking protrusion to be inserted into the recess after the connecting head is pushed and reset to an original shape.

In a preferred embodiment, a gap is defined between the inserting groove and the inserting portion, and the gap defines a space-providing space into which the inserting portion is configured to move to bypass the locking protrusion to enable the locking mechanism to be changed to be in an unlocked state.

A third technical solution of the present disclosure is as follows.

A combined shower comprises a rain shower head and a handheld shower head. The rain shower head is disposed with a hanging portion, and the handheld shower head is disposed with an inserting portion. The inserting portion is configured to be connected upward to the hanging portion, and an attraction mechanism configured to generate an attraction force is disposed between the hanging portion and the inserting portion. The attraction force enables the hanging portion and the inserting portion to be attracted to each other.

A fourth technical solution of the present disclosure is as follows.

A combined shower comprises a rain shower head and a handheld shower head. The rain shower head is disposed with a hanging portion, and the handheld shower head is disposed with an inserting portion. The inserting portion is configured to be connected upward to the hanging portion, and a locking mechanism is disposed between the hanging portion and the inserting portion. The inserting portion comprises a connecting head configured to undergo elastic deformation, and the locking mechanism comprises a locking protrusion protruding from a groove wall of an inserting groove and a recess recessed on the connecting head. When the locking protrusion is inserted into the recess, the locking mechanism is in a locked state.

Compared with the existing techniques, the technical solution has the following advantages.

The attraction mechanism cooperates with the locking mechanism to enable the inserting portion to continue to be held in the locked state, the locking mechanism supports the inserting portion, and the attraction mechanism controls the locking mechanism to be in the locked state, which has a firm hanging ability and is stable and reliable.

The inserting groove has an opening facing downward, and the handheld shower head does not need to be lifted upwards, which is faster and more convenient. Since the handheld shower head can be directly taken downward, a strict height requirement is cancelled, and a popularity of the handheld shower head is increased.

### BRIEF DESCRIPTION OF THE DRAWINGS

FIG. 1 illustrates a perspective view of a combined shower in Embodiment 1.

FIG. 2 illustrates a first cross-sectional view of the combined shower in Embodiment 1 when an inserting portion is detached from a hanging portion.

FIG. 3 illustrates a second cross-sectional view of the combined shower in Embodiment 1 when the inserting portion is inserted into the hanging portion.

FIG. 4 illustrates a partially enlarged view of the combined shower as shown in FIG. 2.

FIG. 5 illustrates a partially enlarged view of the combined shower as shown in FIG. 3.

FIG. 6 illustrates an exploded view of the combined shower in Embodiment 1.

FIG. 7 illustrates a perspective view of the hanging portion in Embodiment 1.

FIG. 8 illustrates a perspective view of the inserting portion in Embodiment 1.

FIG. 9 illustrates a structure diagram of a hanging device in Embodiment 1.

FIG. 10 illustrates a structure diagram of a hanging device in Embodiment 2.

FIG. 11 illustrates a structure diagram of a hanging device in Embodiment 3.

### DETAILED DESCRIPTION OF THE EMBODIMENTS

The present disclosure will be further described below in combination with the accompanying drawings and embodiments.

### Embodiment 1

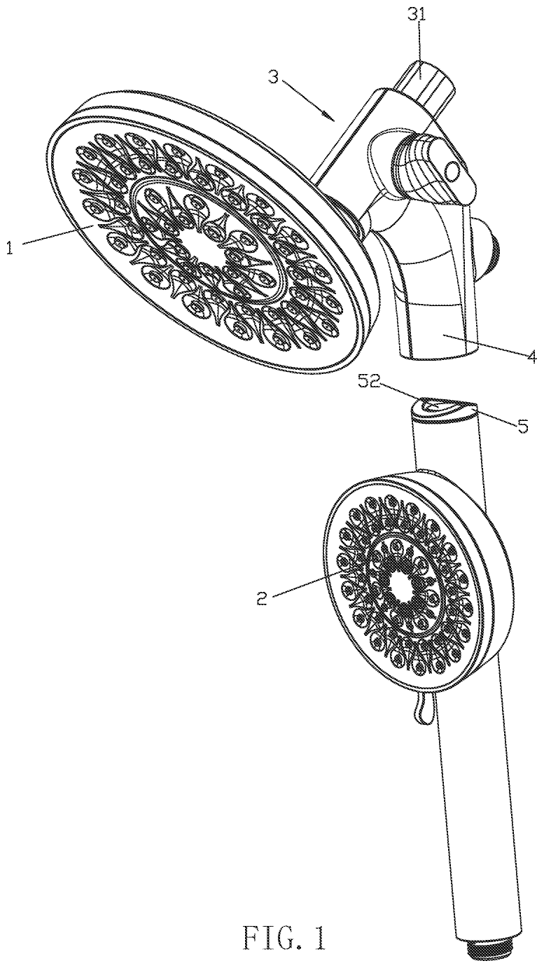

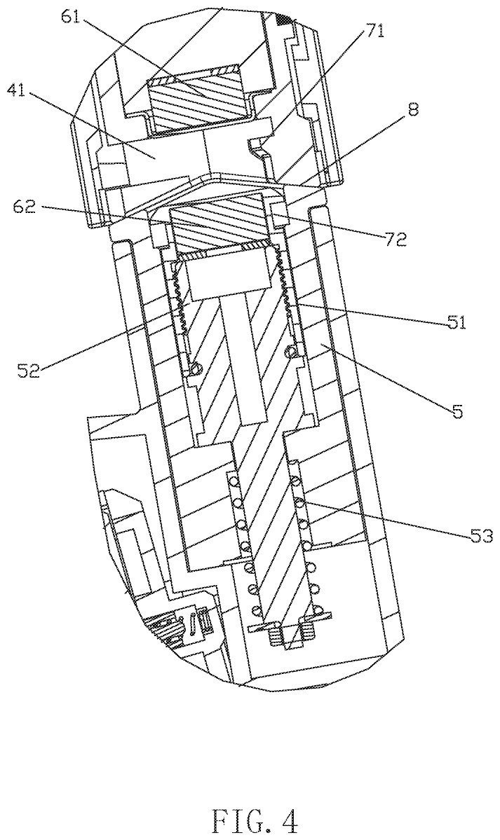

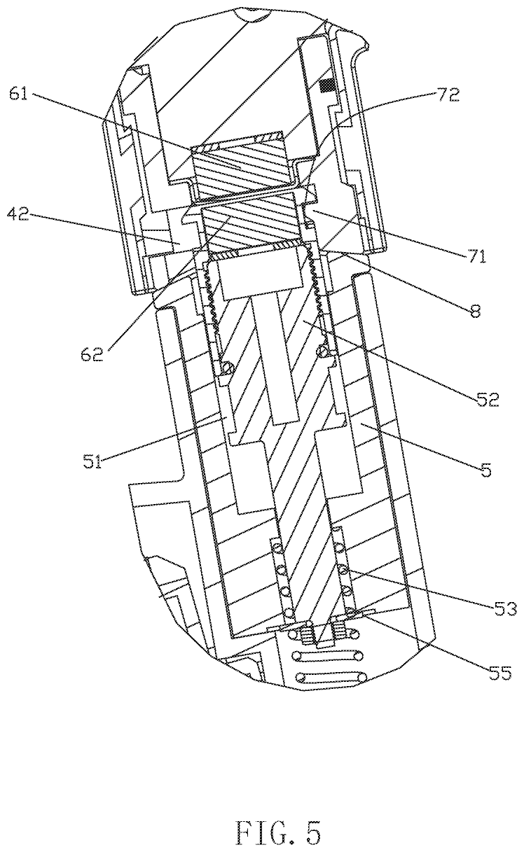

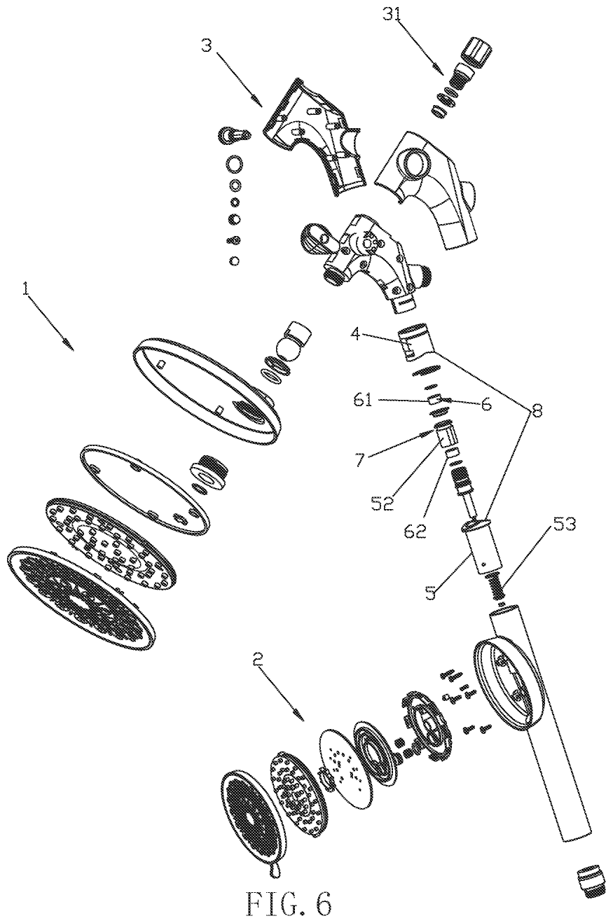

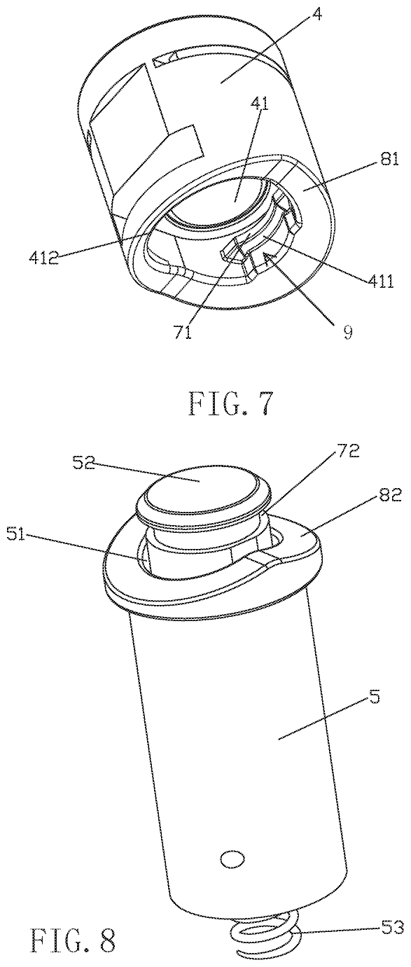

Referring to FIGS. 1-9, a combined shower comprises a rain shower head 1, a handheld shower head 2, and a water passing mechanism 3. The water passing mechanism 3 comprises a three-way valve portion, and the three-way valve portion is configured to be fixedly installed to a wall and comprises a first opening, a second opening, and a third opening. The first opening is in communication with a water supplying pipe through a joint assembly 31. The rain shower head 1 is disposed on the three-way valve portion and is communication with the second opening, and the handheld shower head 2 is communication with the third opening of the three-way valve portion through a water tube. The water passing mechanism 3 is disposed with a hanging portion 4, and the handheld shower head 2 is disposed with an inserting portion 5 (i.e., a wall bracket). The combined shower combines the rain shower head 1 and the handheld shower head 2, and the combined shower has a strong integrated appearance and a compact layout.
The hanging portion 4 comprises an inserting groove 41 having an opening facing downward, and the inserting portion 5 is configured to be inserted upwardly into the inserting groove 41 of the hanging portion 4. An attraction mechanism 6 configured to generate an attraction force is disposed between the hanging portion 4 and the inserting portion 5. The attraction force is a magnetic attraction force, and the attraction mechanism 6 comprises a first member 61 and a second member 62 that are configured to be magnetically attracted to each other. The first member 61 and second member 62 are respectively disposed on the hanging portion 4 and the inserting portion 5, and the attraction force enables the hanging portion 4 and the inserting portion 5 to be attracted to each other. A locking mechanism 7 is disposed between the hanging portion 4 and the inserting portion 5, and the attraction force enables the locking mechanism 7 to be changed from an unlocked state to a locked state and to continue to be in the locked state. A first guiding mechanism 8 is disposed between the hanging portion 4 and the inserting portion 5, and the attraction force cooperates with the first guiding mechanism 8 to enable each of a water discharging surface of the handheld shower head 2 and a water discharging surface of the rain shower head 1 to face a side of the combined shower (i.e., a front side of the combined shower). The present disclosure has the following advantages. 1. The attraction mechanism 6 cooperates with the locking mechanism 7 to enable the inserting portion 5 to continue to be in the locked state, which has a firm, stable, and reliable connection. 2. The inserting groove 41 has an opening facing downward, and the handheld shower head 2 does not need to be lifted upwards, which is faster and more convenient. Since the handheld shower head 2 can be directly taken downward, and a strict height requirement is cancelled to increase a popularity of the combined shower for people with different heights. 3. The first guiding mechanism 8 cooperates with the attraction force to achieve centering the handheld shower head 2 and to ensure that the inserting portion 5 can be inserted to a predetermined position at which the handheld shower head 2 faces the front side of the combined shower.

An upper end surface the inserting portion 5 comprises a sliding groove 51. A sliding piece 52 is slidingly connected to the sliding groove 51, and an elastic body 53 configured to drive the sliding piece 52 to move inwardly is disposed between the sliding piece 52 and the inserting portion 5. Specifically, a distal end of the sliding piece 52 comprises an annular protrusion 55. The elastic body 53 is a spring, and the spring is sleeved on the sliding piece 52 and abuts the annular protrusion 55 and an end face of the inserting portion 5.

The first member 61 is fixedly connected to a bottom of the inserting groove 41, and the second member 62 is fixedly connected to a distal end surface of the sliding piece 52. The magnetic attraction force is disposed along an inserting direction in which the inserting portion 5 is inserted into the inserting groove 41, which has a compact structure, is convenient to assemble, and has a strong magnetic attraction. The first guiding mechanism 8 comprises a first matching surface 81 located on an annular lower end surface of the hanging portion 4 and having a concavo-convex structure and a second matching surface 82 located on an annular upper end surface of the inserting portion 5 and having a concavo-convex structure, and the first matching surface 81 and the second matching surface 82 are matched with each other. The first matching surface 81 is a guiding surface that has a concavo-convex structure, and an angle of the handheld shower head 2 is fixed when the first matching surface 81 and the second matching surface 82 are matched with each other. The matching surfaces guides' movement of the inserting portion 5 to enable the water discharging surface of the handheld shower head 2 and the water discharging surface of the rain shower head 1 to face the side of the combined shower.

The locking mechanism 7 comprises a locking protrusion 71 protruding from a groove wall of the inserting groove 41 and a recess 72 recessed on the sliding piece 52, and the locking mechanism 7 is in the locked state when the locking protrusion 71 is inserted into the recess 72. The sliding piece 52 moves and controls the locking protrusion 71 to be alternatively in the locked state or in the unlocked state, which has a compact structure, has a convenience and accessibility of taking down the handheld shower head 2, and has a reliable guiding structure. An outermost sliding position at which the sliding piece 52 can move outward relative to the inserting portion 5 corresponds to the locked state of the locking mechanism 7 to improve a locking firmness.

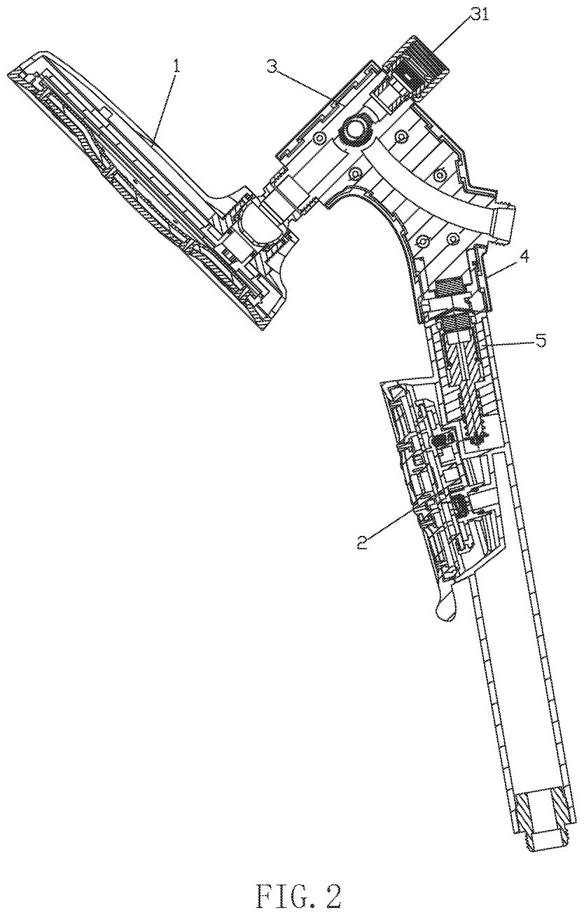

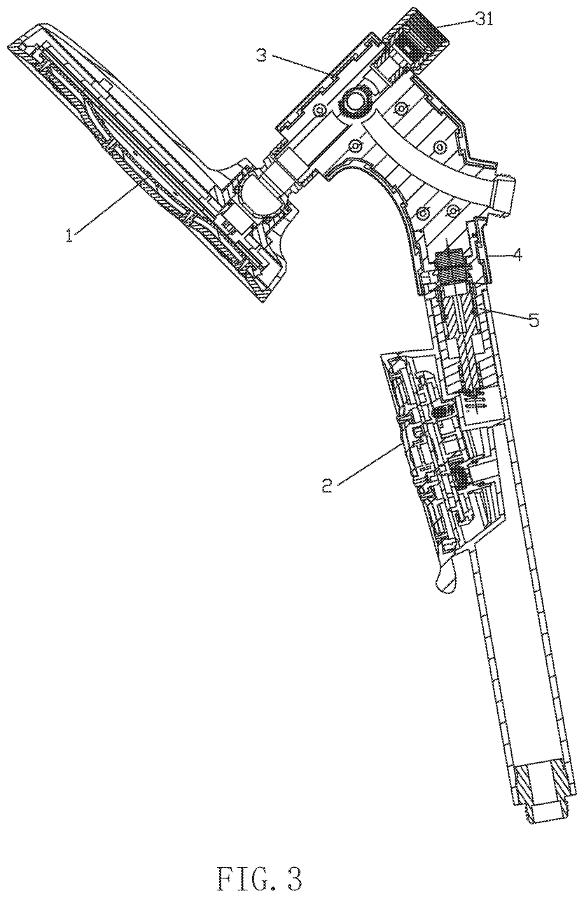

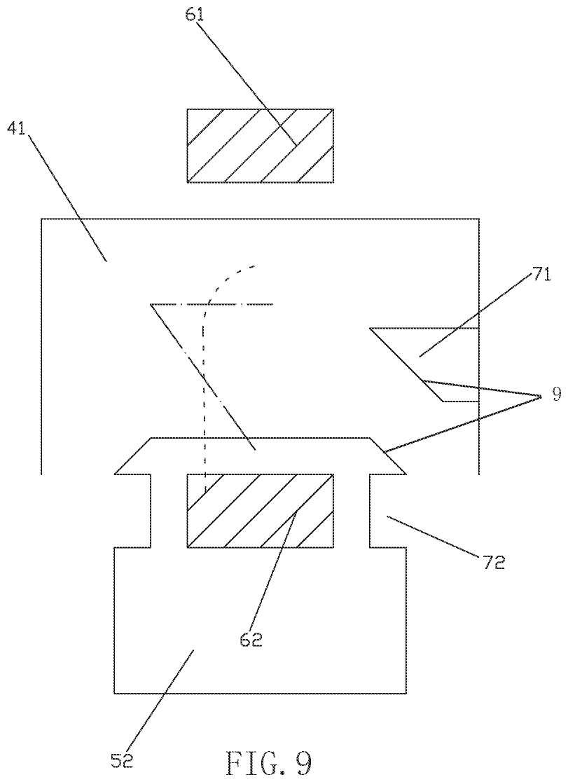

A second guiding mechanism 9 is disposed between the sliding piece 52 and the locking protrusion 71. An outer wall of the sliding piece 52 comprises a circular conical surface, and a bottom wall of the locking protrusion 71 comprises a guiding part 411. In this embodiment, the locking protrusion 71 appears arc-shaped, and the guiding part 411 appears an arc conical surface. The second guiding mechanism 9 comprises the circular conical surface and the guiding part 411. A gap 42 is defined between the inserting groove 41 and the sliding piece 52, and the gap 42 defines a space-providing space into which the sliding piece 52 is configured to move to bypass the locking protrusion 71 to enable the locking mechanism 7 to be changed to be in the unlocked state. The inserting groove 41 comprises a space-providing part 412 defining the gap 42 and facing the guiding part 411. During a process in which the attraction force drives the sliding piece 52 to move toward the bottom of the inserting groove 41: the locking protrusion 71 abuts the sliding piece 52 to make the sliding piece 52 move toward the space-providing part 412 and bypass the locking protrusion 71 when the guiding part 411 abuts the circular conical surface; the sliding piece 52 moves toward the locking protrusion 71 due to the attraction mechanism 6 to make the locking protrusion 71 move into the recess 72 when the sliding piece 52 moves onto the bottom of the inserting groove 41; the sliding piece 52 overlaps the locking protrusion 71; and the inserting portion 5 can continue to be held on the hanging portion 4 under an external force along a center axis of the inserting portion 5. At this time, the locking mechanism 7 is changed to be in the locked state to achieve fastening of the handheld shower head 2. In this embodiment, an inserting motion trail of the inserting portion 5 is similar to a chain dotted line as shown in FIG. 9. When the inserting portion 5 is taken by a user, the inserting portion 5 sways rearward (i.e., sways rightward in FIGS. 2-3) to make the recess 72 leave the locking protrusion 71, so that the inserting portion 5 is pulled downward to be taken and the sliding piece 52 is reset to an original position due to the elastic body 53. In this embodiment, a taking motion trail of the inserting portion 5 is similar to a dashed line as shown in FIG. 9. In this embodiment, the gap 42 is intended to improve a convenience and accessibility of taking down the handheld shower head 2.

### Embodiment 2

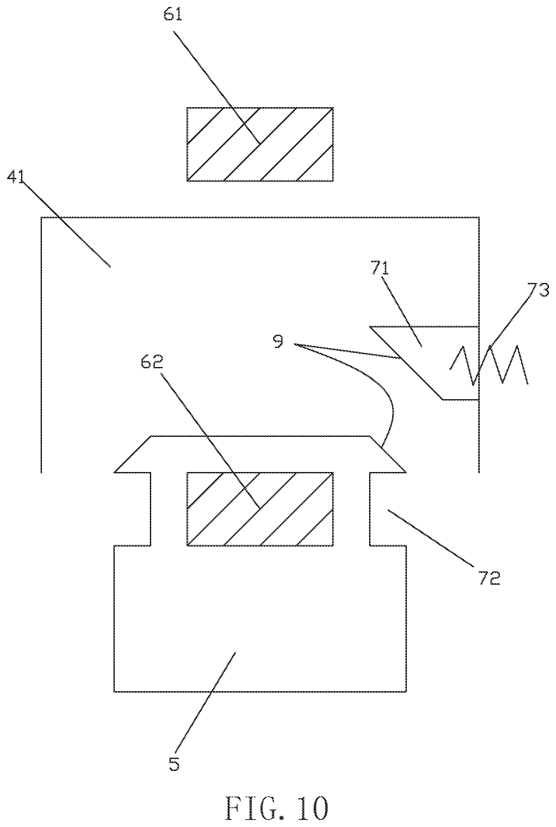

This embodiment is similar to embodiment 1, but has the difference as described below. Referring to FIG. 10, the locking mechanism 7 comprises a locking protrusion 71, a second elastic body 73, and a recess 72 recessed on the inserting portion 5. The locking protrusion 71 is slidingly connected to the hanging portion 4 and is configured to alternatively slide between a protruding position and a retraction position. The second elastic body 73 abuts the locking protrusion 71 to drive the locking protrusion 71 to slide to the protruding position. When the locking protrusion 71 that is at the protruding position is disposed in the recess 72, the locking mechanism 7 is the locked state. A second guiding mechanism 9 is disposed between the inserting portion 5 and the locking protrusion 71, and the attraction force drives the inserting portion 5 to move toward the bottom of the inserting groove 41. When the inserting portion 5 contacts the locking protrusion 71, the attraction force is configured to drive the locking protrusion 71 to move to the retraction position through the second guiding mechanism 9. When the locking protrusion 71 corresponds to the recess 72, the locking protrusion 71 is reset to the protruding position to be inserted into the recess 72. The second guiding mechanism 9 comprises slopes located on the inserting portion 5 and the locking protrusion 71. Since the locking protrusion 71 can slide relative to the groove wall of the inserting groove 41 to provide a space-providing space, the gap 42 between the inserting groove 41 and the sliding piece 52 can be omitted, and the space-providing part 412 can be omitted.

### Embodiment 3

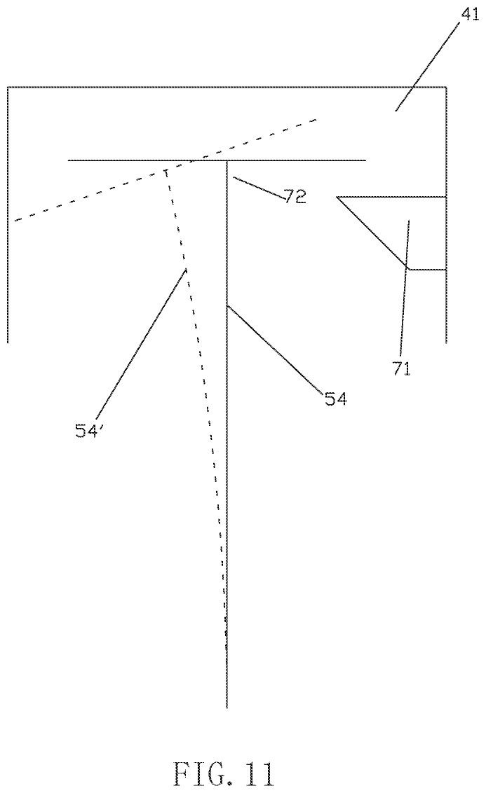

This embodiment is similar to embodiment 1, but has the difference as described below. Referring to FIG. 11, the inserting portion 5 comprises a connecting head 54 configured to undergo elastic deformation. The locking mechanism 7 comprises a locking protrusion 71 protruding from the groove wall of the inserting groove 41 and a recess 72 recessed on the connecting head 54. When the locking protrusion 71 is inserted into the recess 72, the locking mechanism 7 is in the locked state. The attraction force drives the inserting portion 5 to move toward the bottom of the inserting groove 41, and the attraction force makes the connecting head 54 undergo elastic deformation (i.e., a dashed line 54′ as shown in FIG. 11) through the first guiding mechanism 8 when the inserting portion 5 contacts the locking protrusion 71 to enable the locking protrusion 71 to be inserted into the recess 72 after the connecting head 54 is pushed and reset to an original shape.

The aforementioned embodiments are merely some embodiments of the present disclosure, and the scope of the disclosure is not limited thereto. Thus, it is intended that the present disclosure cover any modifications and variations of the presently presented embodiments provided they are made without departing from the appended claims and the specification of the present disclosure.

What is claimed is:

1. A hanging device, comprising:
a hanging portion,
an inserting portion,
a locking mechanism, and
an attraction mechanism, wherein:
the inserting portion is configured to be connected to the hanging portion,
the attraction mechanism is disposed between the hanging portion and the inserting portion and is configured to generate an attraction force,
the attraction force enables the hanging portion and the inserting portion to be attracted to each other,
the locking mechanism is disposed between the hanging portion and the inserting portion,
the attraction force enables the locking mechanism to be changed from an unlocked state to a locked state and to continue to be in the locked state, and
the locking mechanism is configured to be changed from the locked state to the unlocked state by overcoming the attraction force.

2. The hanging device according to claim 1, wherein:
the hanging portion comprises an inserting groove having an opening facing downward, and
the inserting portion is configured to be inserted upward into the inserting groove.

3. The hanging device according to claim 1, wherein:
the hanging portion comprises an inserting groove having an opening facing upward, and
the inserting portion is configured to be inserted downward into the inserting groove.

4. The hanging device according to claim 2, wherein:
the attraction force is a magnetic attraction force,
the attraction mechanism comprises a first member and a second member that are configured to be magnetically attracted to each other, and
the first member and second member are respectively disposed on the hanging portion and the inserting portion.

5. The hanging device according to claim 4, wherein:
the first member is disposed on a bottom of the inserting groove,
the second member is disposed on a distal end of the inserting portion, and
the magnetic attraction force is disposed along an inserting direction in which the inserting portion is inserted into the inserting groove.

6. The hanging device according to claim 2, wherein:
the locking mechanism comprises a locking protrusion protruding from a groove wall of the inserting groove and a recess recessed on the inserting portion, and
when the locking protrusion is inserted into the recess, the locking mechanism is in the locked state.

7. The hanging device according to claim 6, wherein:
the attraction force is configured to drive the inserting portion to move toward a bottom of the inserting groove, and
when the inserting portion contacts the locking protrusion, the inserting portion is pushed away from the locking protrusion and moves to be in the locked state due to the locking mechanism.

8. The hanging device according to claim 7, wherein:
the hanging portion and the inserting portion are disposed with a first guiding mechanism,
the first guiding mechanism comprises a first matching surface located on a lower end surface of the hanging portion and having a first concavo-convex structure and a second matching surface located on an upper end surface of the inserting portion and having a second concavo-convex structure, and
the first matching surface and the second matching surface are matched with each other.

9. The hanging device according to claim 7, wherein:
a second guiding mechanism is disposed between the inserting portion and the locking protrusion, and
when the inserting portion contacts the locking protrusion, the inserting portion is guided to move to be in the locked state through the second guiding mechanism cooperating with the attraction force that drives the inserting portion to move toward the bottom of the inserting groove.

10. The hanging device according to claim 7, wherein:
an upper end surface the inserting portion comprises a sliding groove,
a sliding piece is slidingly connected to the sliding groove,
the sliding piece comprises the recess, and
an outermost sliding position at which the sliding piece is configured to move outward relative to the inserting portion corresponds to the locked state of the locking mechanism.

11. The hanging device according to claim 10, wherein:
an elastic body configured to drive the sliding piece to move inwardly relative to the inserting portion is disposed between the sliding piece and the inserting portion.

12. The hanging device according to claim 7, wherein:
a gap is defined between the inserting groove and the inserting portion, and
the gap defines a space-providing space into which the inserting portion is configured to move to bypass the locking protrusion to enable the locking mechanism to be changed to be in the unlocked state.

13. A hanging device, comprising:
a hanging portion,
a locking mechanism, and
an inserting portion, wherein:
the hanging portion comprises an inserting groove having an opening facing downward,
the inserting portion is configured to be connected upward to the hanging portion,
the locking mechanism is disposed between the hanging portion and the inserting portion,
the inserting portion comprises a connecting head configured to undergo elastic deformation,
the locking mechanism comprises a locking protrusion protruding from a groove wall of the inserting groove and a recess recessed on the connecting head, and
when the locking protrusion is inserted into the recess, the locking mechanism is in a locked state.

14. The hanging device according to claim 13, wherein:
an attraction mechanism configured to generate an attraction force is disposed between the hanging portion and the inserting portion,
the attraction force enables the hanging portion and the inserting portion to be attracted to each other,
a first guiding mechanism is disposed between the hanging portion and the inserting portion,
the attraction force is configured to drive the inserting portion to move toward a bottom of the inserting groove, and
when the inserting portion contacts the locking protrusion, the attraction force makes the connecting head undergo elastic deformation through the first guiding mechanism to enable the locking protrusion to be inserted into the recess after the connecting head is pushed and reset to an original shape.

15. The hanging device according to claim 13, wherein:
a second guiding mechanism is disposed between the locking protrusion and the inserting portion, and
when the inserting portion contacts the locking protrusion, an attraction force makes the connecting head undergo elastic deformation through the second guiding mechanism to enable the locking protrusion to be inserted into the recess after the connecting head is pushed and reset to an original shape.

16. The hanging device according to claim 13, wherein:
a gap is defined between the inserting groove and the inserting portion, and
the gap defines a space-providing space into which the inserting portion is configured to move to bypass the locking protrusion to enable the locking mechanism to be changed to be in an unlocked state.

17. A combined shower, comprising:
a rain shower head, and
a handheld shower head, wherein:
the rain shower head is disposed with a hanging portion,
the handheld shower head is disposed with an inserting portion,
the inserting portion is configured to be connected upward to the hanging portion,
an attraction mechanism configured to generate an attraction force is disposed between the hanging portion and the inserting portion, and
the attraction force enables the hanging portion and the inserting portion to be attracted to each other.

18. A combined shower, comprising:
a rain shower head, and
a handheld shower head, wherein:
the rain shower head is disposed with a hanging portion,
the handheld shower head is disposed with an inserting portion,
the inserting portion is configured to be connected upward to the hanging portion,
a locking mechanism is disposed between the hanging portion and the inserting portion,
the inserting portion comprises a connecting head configured to undergo elastic deformation,
the locking mechanism comprises a locking protrusion protruding from a groove wall of an inserting groove and a recess recessed on the connecting head, and
when the locking protrusion is inserted into the recess, the locking mechanism is in a locked state.
